(19) United States
(12) Patent Application Publication
(10) Pub. No.: US 2026/0184096 A1
(43) Pub. Date: Jul. 2, 2026

(54) METHOD, CONTROL MODULE AND SYSTEM FOR IMAGING A MASK LAYER

(71) Applicant: XSYS PREPRESS NV, IEPER (BE)

(72) Inventor: Dirk Ludo Julien DE RAUW, NINOVE (BE)

(73) Assignee: XSYS PREPRESS NV, IEPER (BE)

(21) Appl. No.: 18/863,885

(22) PCT Filed: May 9, 2023
(86) PCT No.: PCT/EP2023/062252

§ 371 Date: Nov. 7, 2024

(30) Foreign Application Priority Data
May 9, 2022 (NL) 2031806

(51) Int. Cl. B41N 3/03; G06T 3/4092

(52) U.S. Cl. CPC B41N 3/03; G06T 3/4092

(57) ABSTRACT

A method for imaging a mask layer includes providing a mask layer; receiving an image file having imaging pixels and non-imaging pixels at a first resolution R1, based on the image file, generating a modified image file having reduced-resolution imaging pixels and reduced-resolution non-imaging pixels at a second resolution R2 lower than the first resolution R1, where a second pitch P2 corresponds to the second resolution R2, and based on the modified image file, imaging the mask layer such that imaged spots have a largest dimension smaller than (√2*P2), and in some instances smaller than P2.

### FIELD OF INVENTION

The field of the invention relates to methods, control modules and computer programs for imaging a mask layer and for controlling the imaging of a mask layer, in particular a mask layer of a printing plate precursor. The field of the invention further relates to systems for treating a relief precursor, in particular a printing plate precursor, and more in particular a flexographic printing plate precursor or a letterpress plate precursor.

### BACKGROUND

Flexographic printing or letterpress printing are techniques which are commonly used for high volume printing. Flexographic or letterpress printing plates are relief plates with image elements protruding above non-image elements in order to generate an image on a recording medium such as paper, cardboard, films, foils, laminates, etc. Also, cylindrically shaped printing plates or sleeves may be used.

Various methods exist for making flexographic or letterpress printing plate precursors. According to conventional methods flexographic or letterpress printing plate precursors are made from multilayer substrates comprising a backing layer and one or more photocurable layers. Those photocurable layers are imaged by exposure to electromagnetic radiation through a mask layer containing the image information or by direct and selective exposure to light, in order to obtain a relief plate.

In flexographic or letterpress printing, ink is transferred from a plate to a print medium. More in particular, the ink is transferred on the relief parts of the plate, and not on the non-relief parts. During printing, the ink on the relief parts is transferred to the print medium. Greyscale images are typically created using half-toning, e.g. using a screening pattern. By greyscale is meant, for a plate printing in a particular color, the amount of that color being reproduced. For example, a printing plate may comprise different half-tone dot regions to print with different densities in those regions. In order to increase the amount of ink transferred and to increase the so-called ink density on the substrate, an additional very fine structure is applied to the surface of the printing areas, i.e. to the relief areas. This surface screening is typically obtained by adding the fine structure to the raster image file and then transferred to the corresponding mask used for exposure.

WO2021110831A1 in the name of the Applicant describes in FIGS. 1A-1E an example of an existing method for making a relief plate is illustrated. FIG. 1A shows the content of a raster image file having an image file resolution corresponding with a pixel size p (which corresponds with the pitch) of e.g. 6.35 micrometer. The image file resolution may be e.g. 4000 dpi (=25400*1/p (in micrometer)). Next, the raster image file is manipulated using a surface screen pattern which is illustrated in FIG. 1B. The surface screen pattern is applied in the image region 1 resulting in a modified raster image file which is shown in FIG. 1C. As shown in FIG. 1C, the resulting image region 1′ contains fewer pixels 4′ to be printed, and the pixels 4′ to be printed are located at a distance d of each other. Based on the modified raster image file of FIG. 1C, a mask is prepared. More in particular, for every pixel 4′ to be printed, a hole or a transparent region 5 is arranged in the mask. This may be done using a beam of electromagnetic radiation. As shown in FIG. 1D, such a beam will generate a hole 2, here a round hole 2, which is larger than the size of a pixel 4′. The resulting image on the mask is shown in FIG. 1E. Thus, according to the method illustrated in FIGS. 1A-1E, the surface screening is computed by changing the original raster image file, e.g. a tiff file, using software, typically a raster image processing technique, wherein typically due to the manipulation a file having a larger size is generated. WO2021110831A1 further discloses an improved method for processing a raster image file, comprising the steps: receiving of a raster image file comprising image data for a plurality of pixels, analyzing the image data of the raster image file, determining control data, and optionally at least one new raster image file, based on the analyzed image data, said control data being data for controlling settings of an imaging device so as to change the physical properties of generated imaged features corresponding with one or more of the plurality of pixels; outputting the raster image file and/or the new raster image file, with the control data to an imaging device for imaging a relief precursor. In this way the image quality can be improved. For example, depending on whether the image data includes text and/or a photo and/or a bar code and/or large continuous areas, etc., the imaging may be controlled in a different manner.

### SUMMARY

The object of embodiments of the invention is to provide methods, control modules and computer programs which can improve the image quality in an even more robust and simple manner, especially when the image comprises one or more solid areas.

According to a first aspect, there is provided a method for imaging a mask layer. The method comprises the steps: providing of a mask layer; receiving an image file comprising imaging pixels and non-imaging pixels at a first resolution R1; based on the image file, generating a modified image file comprising reduced-resolution imaging pixels and reduced-resolution non-imaging pixels at a second resolution R2 lower than the first resolution R1, wherein a second pitch P2 corresponds to the second resolution R2; based on the modified image file, imaging the mask layer such that imaged spots have a largest dimension smaller than (√2*P2), preferably smaller than P2.

Embodiments of the invention are based on the inventive insight that by first lowering the resolution of the image file and then choosing an appropriate imaging setting so that the imaged spots do not fully overlap, a fine surface structure can be obtained in a simple manner without requiring complex manipulations of the image file. This will result in a good image quality, especially when the image file contains one or more solid areas. Indeed, by using a suitable lowered resolution in a solid area an appropriate surface structure can be obtained on the corresponding solid printing relief of a printing plate, and ink on a solid printing relief will be more evenly distributed. As such the trailing edge voids can be much reduced. Indeed, channels will be created in the upper surface of a solid relief such that a resulting printing relief is not in contact with the substrate over a too large area while printing.

According to a second aspect there is provided a method for imaging a mask layer. The method comprises the steps: providing a mask layer; receiving an image file comprising imaging pixels and non-imaging pixels at a first resolution R1; based on the image file, generating signals corresponding to reduced-resolution imaging pixels and reduced-resolution non-imaging pixels at a second resolution R2 lower than the first resolution R1, wherein a second pitch P2 corresponds to the second resolution R2; based on the signals, imaging the mask layer such that imaged spots have a largest dimension smaller than (√2*P2), preferably smaller than P2.

The second aspect is similar to the first aspect, but here the lowering of the resolution is done in the hardware without necessarily creating a modified image file. Thus, according to the second aspect, the image file, typically a raster image file, may be sent to a control module for controlling the imaging without further processing/manipulating the image data in the image file, and the lowering of the resolution may be done “on the fly” in the hardware.

It is noted that the pitch corresponds with the distance between the centres of adjacent pixels of a row and that this distance is typically equal to the pixel size. A first pitch P1 corresponds with the first resolution R1, and a second pitch P2 corresponds with the second lower resolution.

Preferably, the second resolution R2 and the imaging settings used for the imaging are chosen such that, after exposing a relief precursor through the imaged mask layer and developing an exposed relief precursor, a surface structure of hills surrounded by valleys is generated on a printing relief corresponding with a solid area.

Preferably, the imaging is done such that a largest dimension of the imaged spots is smaller than ⅓*P1+⅔*P2, preferably smaller than (P1+P2)/2, or even smaller than P1, and/or preferably larger than P1/2. In such embodiments the image spots will not overlap and can generate an appropriate fine surface structure for printing a solid area.

Preferably, the second resolution R2 is less than two-thirds of the first resolution R1, preferably equal to or less than half of the first resolution R1, and/or preferably no more than three times smaller than the first resolution R1. The inventors have found that such resolution reductions provide a good compromise between accuracy and ink density.

In an exemplary embodiment, the generating comprises determining that a reduced-resolution pixel of the modified image file is a reduced-resolution imaging pixel if the reduced-resolution pixel includes more imaging pixels than or the same number as non-imaging pixels in the image file, and, if not, determining that a reduced-resolution pixel is a reduced-resolution non-imaging pixel.

In an exemplary embodiment, prior to or during the imaging of the mask layer, a sampling pattern is superimposed on the reduced-resolution pixels so that only a portion of the reduced-resolution imaging pixels is imaged. Although, for some application this may be preferred, in many applications good results may be obtained when no sampling pattern is superimposed on the reduced-resolution pixels prior to or during the imaging of the mask layer.

It is further noted that a sampling pattern may be applied in some areas of the modified image file and not in others. For example, in very large solid areas, a sampling pattern may be added while in other smaller areas no sampling pattern is superimposed.

Alternatively or in addition, prior to the generating, a sampling pattern is superimposed on pixels of the image file to obtain a sample image file in which a portion of the imaging pixels of the image file is changed into non-imaging pixels, and wherein the generating is based on the sampled image file. Thus, a sampling pattern may be added in the original image file before the resolution is lowered. Also in that case, a sampling pattern may be applied in some areas of the original image file and not in others. Further, the sampling pattern used in the original image file may be different from the sampling pattern used in the modified image file. Typically, because of the already lowered resolution, it will be preferred to use a rather dense sampling pattern such as a checkerboard pattern, in the modified image file, while a less dense sampling pattern could be used in the original image file.

Preferably, the sampling pattern is a repetition of a block in which one or more imaging pixels are combined with one or more non-imaging pixels. Alternating imaging pixels with non-imaging pixels across the whole block leads to a regular sampling i.e. a regular selection of the imaging pixels over the whole block. For example, the sampling pattern is any one of the following or a combination thereof: a single pixel pattern, such as a single pixel checkerboard pattern, a pattern for which each imaging pixel is surrounded by eight non-imaging pixels; a multiple pixel pattern, such as a multiple pixel checkerboard pattern where e.g. a cluster of four imaging pixels or four non-imaging pixels corresponds with a case of the checkerboard; a line pattern; a dash pattern (such as interrupted lines); a circle pattern, a grid pattern.

According to an exemplary embodiment, the imaging is done such that all imaged spots have substantially the same dimensions and/or shape. According to another exemplary embodiment, the imaging is done such that the dimensions and/or shape of the imaged spots are changed according to a regular or irregular pattern. Such different dimension and/or shape may be achieved by controlling the imaging settings, an in particular by controlling any one or more of the following imaging settings:
an intensity value to be used for generating an imaged feature corresponding with a reduced-resolution imaging pixel, e.g. an intensity value for controlling a beam used for the imaging of the reduced-resolution imaging pixels of a solid area,
a time interval to be used for generating an imaged feature corresponding with a reduced-resolution imaging pixel, e.g. an on-time value for controlling a beam used for the imaging of the reduced-resolution imaging pixels of a solid area,
a beam diameter value or beam shape value for controlling a beam used for the imaging of the reduced-resolution imaging pixels,
a number of passes used for the imaging of the reduced-resolution imaging pixels of a solid area,
an indication of an exposure head of a plurality of exposure heads to be used for generating an imaged feature or a group of imaged features corresponding to a pixel or a group of pixels of the reduced-resolution imaging pixels.

According to an exemplary embodiment, the modified image file is generated so that it has at least two bits per reduced resolution pixel, said at least two bits indicating for each reduced resolution pixel whether the pixel is one of the following: a reduced resolution non-imaging pixel, a reduced resolution imaging pixel to be imaged with a first imaging setting, a reduced resolution imaging pixel to be imaged with a second imaging setting different from the first imaging setting, optionally a reduced resolution imaging pixel to be imaged with a third imaging setting different from the first and second imaging setting, wherein the imaging is done based on the modified image file. These features integrate an indication of the imaging setting to be used into a single modified image file. During the imaging of the mask layer, it is then only necessary to extract information from this modified image file without having to refer to other files and/or without the need for having multiple raster image files. Thus, by generating such a modified imaging file, the imager can be instructed in a convenient manner, whilst allowing to vary the imaging settings. In this way the imaging settings can be changed during the imaging in a convenient manner.

According to an exemplary embodiment, the method further comprises detecting at least one solid area and at least one halftone area in the image file, wherein the generating of the modified image file is done based on the pixels of the at least one solid area, and the modified image file is used to image the at least one solid area. If any halftone areas are present, such areas may then be imaged in a different manner, e.g. based on the image file at the first resolution, optionally with a sampling pattern being applied on the one or more halftone areas.

According to another exemplary embodiment, the method further comprises detecting at least one interior area and at least one edge area in the image file, and the generating of the modified image file is done based on the pixels of the at least one interior area, and the modified image file is used to image the at least one interior area. The at least one interior area and the at least one edge area may comprise an interior area and an edge area of a solid area, and/or an interior area and an edge area of a dot of a halftone area. The one or more edge areas may be imaged in a different manner, e.g. based on the image file at the first resolution.

According to another exemplary embodiment, the method further comprises detecting at least one interior area and at least one edge area in the modified image file. Optionally, sampling pattern may be applied on the at least interior area, wherein on the at least one edge area no sampling pattern or a different sampling pattern may be applied. In addition or alternatively, the one or more edge areas may be imaged in a different manner, e.g. using a different imaging setting as compared with the one or more interior areas. The at least one interior area and the at least one edge area may comprise an interior area and an edge area of a solid area, and/or an interior area and an edge area of a dot of a halftone area.

Preferably, the image file is a raster image file. The raster image file may be a 1 BPP (1 bit per pixel) file or a multi-level image file with multiple bits per pixel (e.g. such that a pixel can have various grey levels). The raster image file may have any one of the following file formats: TIFF, LEN, JPEG, JPG, BMP, JDF, PNG, etc.

In exemplary embodiments, a raster image processing (RIP) module converts a source image file, such as a pdf file or a ps file, into a raster image file which corresponds with the image file having the first resolution R1 mentioned above. The RIP module is a component used in image processing which produces a raster image file also known as a bitmap, which is a pixel-based format. The source image file may be a page description in a high-level page description language such as PostScript, Portable Document Format, XPS or another bitmap. In the latter case, the RIP applies either smoothing or interpolation algorithms to the input bitmap to generate the output bitmap. Raster image processing is the process of turning e.g. vector digital information such as a PostScript file into a high-resolution raster image file. Usually the RIP module is implemented either as a software component of an operating system or as a firmware program executed on a microprocessor. The RIP module may further have a layout function. When a plurality of small images needs to printed, those images may be grouped according to print patterns. This grouping may also be done by the RIP module.

Optionally, the raster image file may include raster image processed data, i.e. bitmap data, as well as vector coordinates corresponding to image patches. Alternatively, the raster image file with raster image processed data may be part of a job file which further comprises vector coordinates. The raster image processed data, i.e. the bitmap data, and associated vector coordinates corresponding to the image patches may be used as an input for processing the raster image processed data to automatically create one or more raster image processed image patches. One or more register marks may be attached to each such image patch, and the one or more image patches with register marks and the corresponding vector coordinates for each image patch may be stored in a processing file for creating a printing plate. Also, mounting device information, a bar code and other information may be associated thereto, and saved to the processing file. In one embodiment, bitmap information may be stored in a first layer of a template file with the vector coordinates for each image patch stored in a second layer of the template file. In another embodiment, bitmap information may be stored in a first file and the vector coordinates for each image patch may be stored in a second file associated with the first file.

According to a third aspect there is provided a method for imaging a mask layer, comprising the steps: provision of a mask layer; receiving an image source file; based on the image source file, generating a first raster image file comprising imaging pixels and non-imaging pixels at a first resolution R1; and a second raster image file comprising reduced-resolution imaging pixels and reduced-resolution non-imaging pixels at a second resolution R2 lower than the first resolution R1; wherein a second pitch P2 corresponds to the second resolution R2; based on the second raster image file, imaging the mask layer such that imaged spots have a largest dimension smaller than (√2*P2), preferably smaller than P2. The mask layer may be further imaged based on the first raster image file, typically in a different pass, preferably such that the imaged spots have a largest dimension smaller than (√2*P1), more preferably smaller than P1.

The preferred ranges and values for R2 and R1 disclosed above for the first and second aspect equally apply for the third aspect, as well as for the aspects below. Also, a sampling pattern may be superimposed on the pixels of the first and/or second raster image file. The sampling pattern may be any one of the patterns disclosed above. Also, the imaging based on the second raster image file may be done such that all imaged spots produced have substantially the same dimensions and/or shape; or such that the dimensions and/or shape of the imaged spots are changed according to a regular or irregular pattern. Further, the imaging based on the first raster image file may be done such that all imaged spots have the same dimensions and/or shape (which may be the same or different from the imaged spots produced based on the second raster image file) or such that the dimensions and/or shape of the imaged spots are changed according to a regular or irregular pattern (which may be the same or different from the pattern used in combination with the second raster image file).

The source image file may be a page description in a high-level page description language such as PostScript, Portable Document Format, XPS. The first and/or second raster image file may be a 1 BPP (1 bit per pixel) file or a multi-level image file with multiple bits per pixel (e.g. such that a pixel can have various grey levels). The first and/or second raster image file may have any one of the following file formats: TIFF, LEN, JPEG, JPG, BMP, JDF, PNG, etc.

Optionally, the first and/or the second raster image file is generated so that it has at least two bits per pixel, said at least two bits indicating for each pixel whether the pixel is one of the following:
a non-imaging pixel,
an imaging pixel to be imaged with a first imaging setting,
an imaging pixel to be imaged with a second imaging setting different from the first imaging setting,
optionally an imaging pixel to be imaged with a third imaging setting different from the first and second imaging setting,
wherein the imaging is done based on the first and second raster image file.

The invention further relates to a mask layer obtained by the method of any one of the previous embodiments.

Optionally, the mask layer is provided on a photopolymerizable layer of a relief precursor as an integral part of a relief precursor and, after the imaging, the photopolymerizable layer of the relief precursor is exposed through the mask layer and the relief precursor is developed to obtain a relief structure. The invention further relates to a relief structure obtained by this method. The relief precursor may be a precursor for an element selected from the group comprising: a flexographic printing plate, a relief printing plate, a letter press plate, an intaglio plate, a (flexible) printed circuit board, an electronic element, a microfluidic element, a micro reactor, a phoretic cell, a photonic crystal and an optical element, a Fresnel lens.

The mask layer can be a separate layer, which is applied to the relief precursor, typically following the removal of a protective layer that may optionally be present, or an integral layer of the precursor, which is in contact with the relief layer or one of the optional layers above the relief layer, and is covered by a protective layer that may possibly be present. The mask layer can also be a commercially available negative which, for example, can be produced by means of photographic methods based on silver halide chemistry. The mask layer can be a composite layer material in which, by means of image-based exposure, transparent layers are produced in an otherwise non-transparent layer, as described, for example in EP 3 139 210 A1, EP 1 735 664 B 1, EP 2987 030, A1 EP 2 313 270 B 1. This can be carried out by ablation of a non-transparent layer on a transparent carrier layer, as described, for example, in U.S. Pat. No. 6,916,596, EP 816 920 B1, or by selective application of a non-transparent layer to a transparent carrier layer, as described in EP 992 846 B1, or written directly onto the relief-forming layer, such as, for example, by printing with a non-transparent ink by means of ink-jet, as described, for example, in EP 1 195 645 A1.

Preferably, the mask layer is an integral layer of the relief precursor and is located in direct contact with the relief-forming layer or a functional layer which is arranged on the relief-forming layer, which is preferably a barrier layer. Furthermore, the integral mask layer can be imaged by ablation and in addition removed with solvents or by heating and adsorbing/absorbing. For example, this layer may be heated and liquefied by means of selective irradiation by means of high-energy electromagnetic radiation, which produces an image-based structured mask, which is used to transfer the structure to the relief precursor. For this purpose, it may be opaque in the UV range and absorb radiation in the visible IR range, which leads to the heating of the layer and the ablation thereof. Following the ablation, the mask layer also represents a relief, typically with lower relief heights, for example in the range from 0.1 to 5 μm. In an exemplary embodiment, the optical density of the mask layer in the UV range from 330 to 420 nm and/or in the visible IR range from 340 to 660 nm lies in the range from 1 to 5, preferably in the range from 1.5 to 4, particularly preferably in the range from 2 to 4. The layer thickness of the laser-ablatable mask layer is generally 0.1 to 5 μm. Preferably, the layer thickness is 0.3 to 4 μm, particularly preferably 1 μm to 3 μm. The laser sensitivity of the mask layer (measured as the energy which is needed to ablate a 1 cm2 layer) may be between 0.1 and 10 mJ/cm2, preferably between 0.3 and 5 mJ/cm2, particularly preferably between 0.5 and 5 mJ/cm2.

According to another aspect there is provided a computer program or computer program product or digital storage means comprising computer-executable instructions to control the method of any one of the previous embodiments, when the program is run on a computer.

According to a further aspect, there is provided a control module configured for receiving an image file comprising imaging pixels and non-imaging pixels at a first resolution R1; based on the image file, generating a modified image file comprising reduced-resolution imaging pixels and reduced-resolution non-imaging pixels at a second resolution R2 lower than the first resolution R1, or generating signals corresponding to reduced-resolution imaging pixels and reduced-resolution non-imaging pixels at the second resolution R2; wherein a second pitch P2 corresponds to the second resolution R2; based on the modified image file or the generated signals, controlling imaging of a mask layer such that imaged spots have a largest dimension smaller than (√2*P2), preferably smaller than P2.

The technical benefits set out above for embodiments according to the first and second aspect apply mutatis mutandis for embodiments of the control module.

Preferably, the control module is configured to determine that a reduced-resolution pixel of the modified image file is a reduced-resolution imaging pixel if the reduced-resolution pixel includes more imaging pixels than or the same number as non-imaging pixels in the image file, and, if not, to determine that a reduced-resolution pixel is a reduced-resolution non-imaging pixel.

Preferably, the control module is configured to superimpose a sampling pattern on the reduced-resolution pixels so that only a portion of the reduced-resolution imaging pixels is imaged. Preferably, the control module is configured to control the imaging such that all imaged spots have substantially the same dimensions and/or shape; or such that the dimensions and/or shape of the imaged spots are changed according to a regular or irregular pattern.

Preferably, the control module is configured to generate, based on the image file, a modified image file having at least two bits per reduced resolution pixel, said at least two bits indicating for each reduced resolution pixel whether the pixel is one of the following: a reduced resolution non-imaging pixel, a reduced resolution imaging pixel to be imaged with a first imaging setting, a reduced resolution imaging pixel to be imaged with a second imaging setting different from the first imaging setting, optionally a reduced resolution imaging pixel to be imaged with a third imaging setting different from the first and second imaging setting, and to control the imaging based on the modified image file.

According to another aspect there is provided a control module configured for receiving an image source file; based on the image source file, generating a first raster image file comprising imaging pixels and non-imaging pixels at a first resolution R1; and a second raster image file comprising reduced-resolution imaging pixels and reduced-resolution non-imaging pixels at a second resolution R2 lower than the first resolution R1; wherein a second pitch P2 corresponds to the second resolution R2; and, based on the second raster image file, controlling imaging of a mask layer such that imaged spots have a largest dimension smaller than (√2*P2), preferably smaller than P2.

The control module may be further configured to control the imaging based on the first raster image file, typically in a different imaging pass, and preferably such that the imaged spots have a largest dimension smaller than (√2*P1), more preferably smaller than P1.

Also, the control module may be configured to superimpose a sampling pattern on the pixels of the first and/or second raster image file. The sampling pattern may be any one of the patterns disclosed above. Also, the control module may be configured to control the imaging based on the second raster image file such that all imaged spots produced have substantially the same dimensions and/or shape; or such that the dimensions and/or shape of the imaged spots are changed according to a regular or irregular pattern. Further, the control module may be configured to control the imaging based on the first raster image file such that all imaged spots have the same dimensions and/or shape (which may be the same or different from the imaged spots produced based on the second raster image file) or such that the dimensions and/or shape of the imaged spots are changed according to a regular or irregular pattern (which may be the same or different from the pattern used in combination with the second raster image file).

Optionally, the control module may be configured for to generate the first and/or the second raster image file so that it has at least two bits per pixel, said at least two bits indicating for each pixel whether the pixel is one of the following: a non-imaging pixel, an imaging pixel to be imaged with a first imaging setting, an imaging pixel to be imaged with a second imaging setting different from the first imaging setting, optionally an imaging pixel to be imaged with a third imaging setting different from the first and second imaging setting, wherein the imaging is controlled based on the first and second raster image file.

According to a further aspect, there is provided a system for treating a relief precursor, comprising an imager configured to image a mask layer; and a control module according to any one of the above described embodiments to control the imager. The imager may be a device which selectively removes parts of a mask layer, changes the transmission of a mask layer or selectively adds a non-transparent material to a substrate layer or relief precursor. Preferably, the imager removes parts of a mask layer or changes the transmission of a mask layer and this may be achieved by using beams of electromagnetic radiation. Most preferably the imager removes parts of a mask layer by ablation wherein beams of electromagnetic radiation are employed. Preferably, the wavelength of the beams of electromagnetic radiation is in the range of 700 nm to 12.000 nm.

Optionally, the system further comprises any one or more of the following: at least one transport system configured to transport the relief precursor, a storage device, an exposure means configured to expose the relief precursor through the imaged mask layer, a developing means configured to remove at least a part of non-exposed material from the relief precursor, a drying system, a post-exposure device, a cutting device, a mounting station, a heater.

According to a further aspect of the invention, there is provided a system having a user interface offering a user a selection between different imaging methods, preferably including the imaging method of the first aspect and/or of the second aspect and/or of the third aspect. Optionally the system may be configured to query the imager in order to obtain the capabilities of the imager (e.g. supported imaging methods, supported resolutions, information about possible settings of the imaging beams, etc.), and based on the obtained information, the information presented by the user interface to the user may be adapted.

### BRIEF DESCRIPTION OF THE FIGURES

The accompanying drawings are used to illustrate presently preferred non-limiting exemplary embodiments of methods, control modules and systems of the present invention. The above and other advantages of the features and objects of the invention will become more apparent and the invention will be better understood from the following detailed description when read in conjunction with the accompanying drawings, in which:

FIG. 1 illustrates schematically an exemplary embodiment of a method for imaging a mask layer.

FIGS. 2A-2E illustrate schematically different structures of image spots.

FIGS. 3 and 4 illustrate schematically other exemplary embodiments of methods for imaging a mask layer.

FIGS. 5A and 5B represent images of a surface structure of solid areas of an exposed and developed printing plate which was imaged in accordance with exemplary embodiments of the method.

FIGS. 6A-E illustrate exemplary embodiments of sampling pattern which may be used in exemplary embodiments.

FIG. 7 illustrates a schematic view of an exemplary embodiment of a system for producing a relief printing plate/sleeve.

FIG. 8 illustrates a schematic view of an exemplary embodiment of a control module arranged downstream of a RIP module.

FIG. 9 illustrates a schematic view of another exemplary embodiment of a control module.

FIGS. 10 and 11 illustrate schematically other embodiments of methods for imaging a mask layer.

### DETAILED DESCRIPTION OF EMBODIMENTS

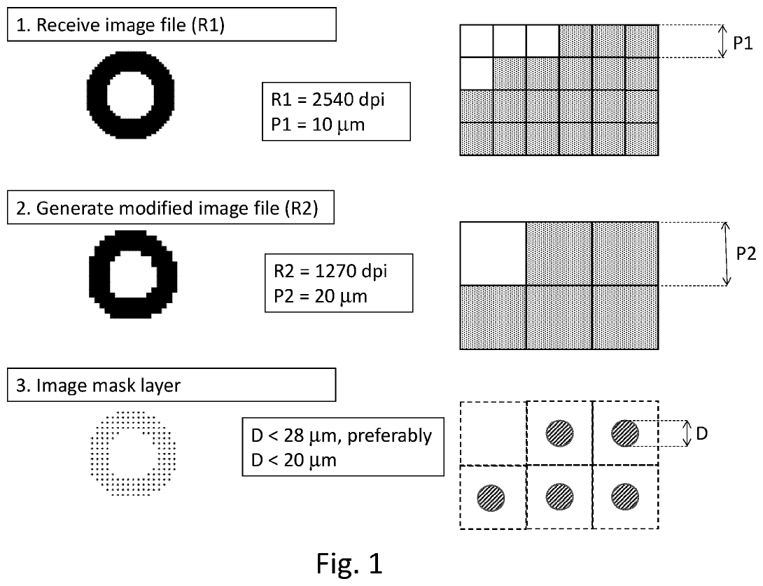

FIGS. 1, 3 and 4 illustrate different exemplary embodiments of methods for imaging a mask layer, and in particular an area of a mask layer corresponding to a solid area. In FIGS. 1, 3 and 4 the solid area is a circular area, but the skilled person understands that this area may have any shape.

In a first step of the method of FIGS. 1, 3 and 4 an image file comprising imaging pixels and non-imaging pixels at a first resolution R1. The imaging pixels are represented as black squares. In a second step of FIGS. 1, 3 and 4 a modified image file is generated based on the image file having the first resolution. The modified image file comprises reduced-resolution imaging pixels (shown in black) and reduced-resolution non-imaging pixels at a second resolution R2 lower than the first resolution R1. A first pitch P1 corresponds to the first resolution R1, and a second pitch P2 corresponds to the second resolution R2. The generating may comprise determining that a reduced-resolution pixel of the modified image file is a reduced-resolution imaging pixel if the reduced-resolution pixel includes more imaging pixels than or the same number as non-imaging pixels in the image file, and, if not, determining that a reduced-resolution pixel is a reduced-resolution non-imaging pixel.

In the example, R1 is e.g. 2540 dpi corresponding with a pitch of 10 micron, and R2 is 1270 dpi with a pitch of 20 micron. However, those value may be different in other examples. Another example is R1=5080 dpi and R2=2540 dpi or R2=5080/3 dpi or R2=1270 dpi. Preferably, the second resolution R2 is less than two-thirds of the first resolution R1, more preferably equal to or less than half of the first resolution R1, and/or preferably no more than 3 times smaller than the first resolution R1 unless the first resolution R1 is high enough to allow a further decrease in resolution.

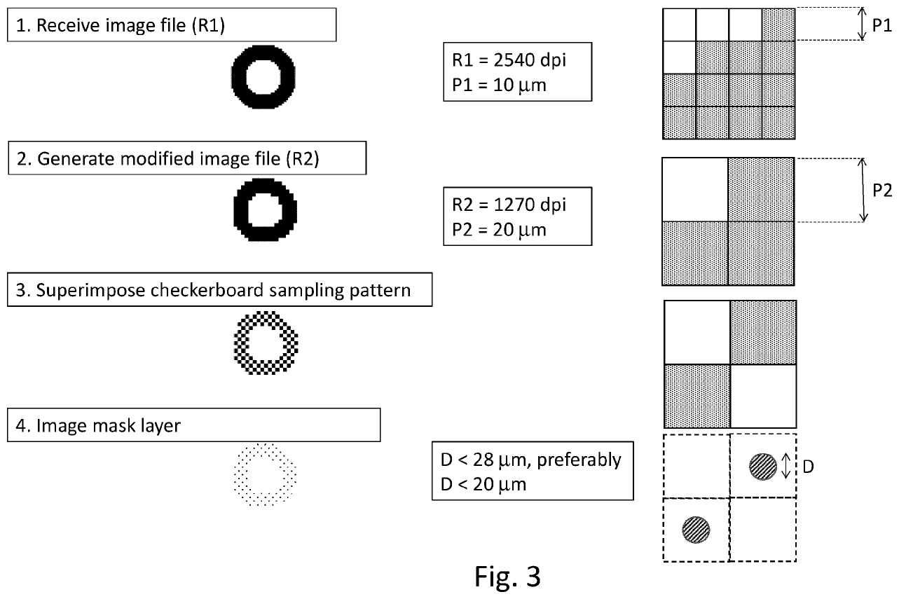

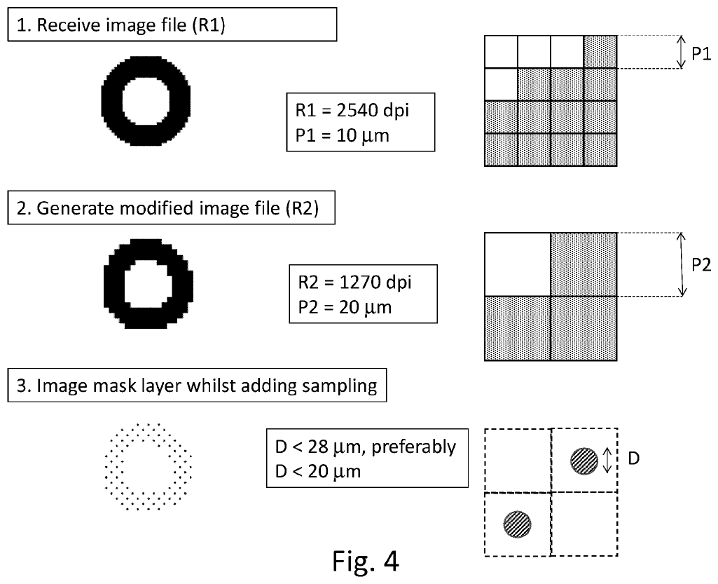

Optionally, in a next step illustrated in FIGS. 3 and 4, prior to or during the imaging of the mask layer, a sampling pattern is superimposed on the reduced-resolution pixels so that only a portion of the reduced-resolution imaging pixels is imaged. In FIG. 3 the sampling pattern is added in the modified image file prior to the imaging, while in FIG. 4 the sampling pattern is added “on the fly” during the imaging. In the embodiment of FIG. 1 no sampling pattern is superimposed on the reduced-resolution pixels prior to or during the imaging of the mask layer. In yet other not illustrated embodiments a sampling pattern could be superimposed on pixels of the image file to obtain a sample image file in which a portion of the imaging pixels of the image file is changed into non-imaging pixels, and wherein the generating of the modified image file is based on the sampled image file.

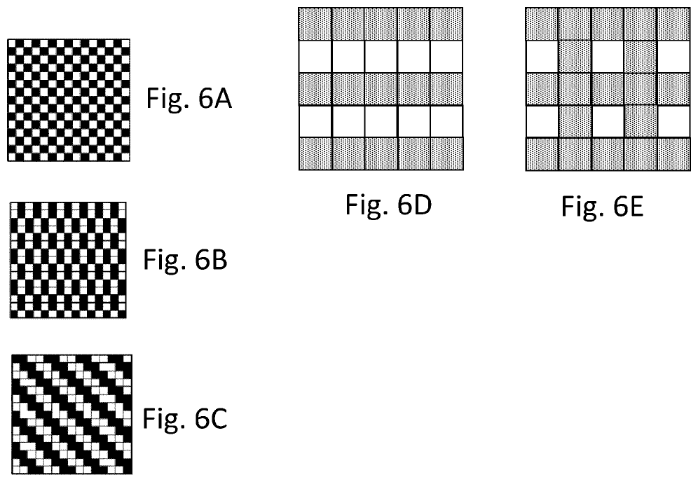

Preferably, the sampling pattern is a repetition of a block in which one or more imaging pixels are combined with one or more non-imaging pixels. In the example of FIGS. 3 and 4 a checkerboard sampling pattern is used. However, other sampling patterns may also be used. FIGS. 6A-6E illustrate different sampling patterns that may be used. FIG. 6A is a single pixel pattern, here a single pixel checkerboard pattern. FIG. 6B is multiple pixel pattern, here a two-pixel checkerboard pattern. FIG. 6C is a two-pixel line pattern. FIG. 6D is another line pattern comprising lines aligned with a pixel row or column. FIG. 6E is a grid pattern comprising lines aligned with rows of pixels and lines aligned with columns of pixels. Preferably, the sampling pattern is a rather dense pattern when in is applied to the modified lower resolution file. However, when a sampling pattern is applied to the image file with the first resolution, also less dense sampling patterns may be used such as a pattern for which each imaging pixel is surrounded by at least eight non-imaging pixels.

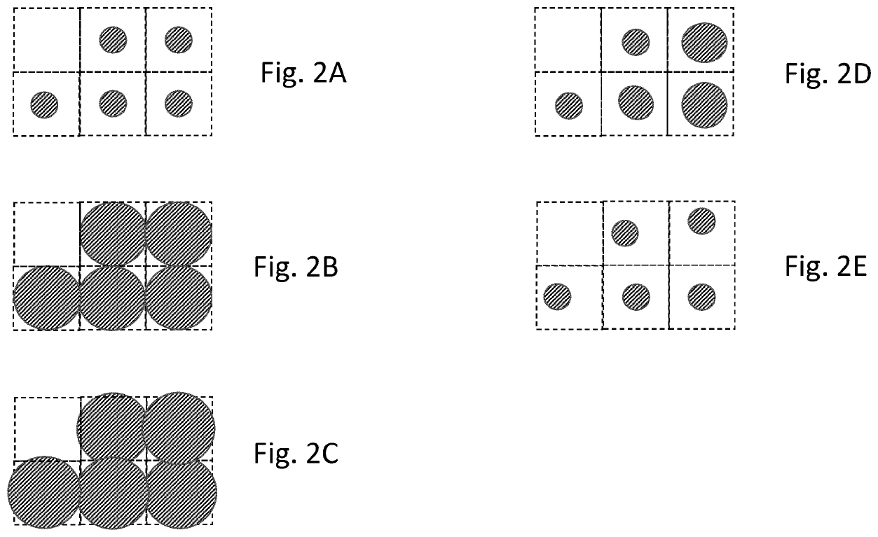

In a last step of the embodiments of FIGS. 1, 3 and 4, the mask layer is imaged using the modified image file such that the imaged spots have a largest dimension smaller than (√2*P2), preferably smaller than P2. For example, the imaged spots may have a size smaller than 28*28 micron, more preferably smaller than 20*20 micron for the illustrated example. More preferably, the imaging is done such that a largest dimension of the imaged spots is smaller than ⅓*P1+⅔*P2, even more preferably smaller than (P1+P2)/2, or even smaller than P1, and preferably larger than P1/2. The imaging may be done such that all imaged spots have substantially the same dimensions and shape as is shown in FIGS. 1, 3 and 4. FIGS. 2A-2E show further examples of how the shape and/or size of the image spots may be controlled. FIG. 2A corresponds with what is shown in FIGS. 1, 3 and 4, where the diameter D of the spots is well below P2 and even smaller than P1. In the example of FIG. 2B D is equal to P2 so that the imaged spots touch each other, and the in the example of FIG. 2C D is larger than P2 so that the imaged spots overlap. In the example of FIG. 2D, the imaging was done such that the dimensions and/or shape of the imaged spots are changed according to a regular or irregular pattern. Further, as is shown in FIG. 2E, the position of the imaged spots may also be changed with respect to one another. All pixels of a row and/or column may be aligned as in FIGS. 2A-2C or some pixels may be shifted away from a central position, as in FIG. 2E.

In some exemplary embodiments, the modified image file is generated so that it has at least two bits per reduced resolution pixel, said at least two bits indicating for each reduced resolution pixel whether the pixel is one of the following: a reduced resolution non-imaging pixel, a reduced resolution imaging pixel to be imaged with a first imaging setting, a reduced resolution imaging pixel to be imaged with a second imaging setting different from the first imaging setting, optionally a reduced resolution imaging pixel to be imaged with a third imaging setting different from the first and second imaging setting, wherein the imaging is done based on the modified image file. For example the first image setting may be representative for a first diameter of the imaged spot and/or for a first shape of the imaged spot and/or for a first position of the imaged spot, and the second image setting may be representative for a second diameter of the imaged spot and/or for a second shape of the imaged spot and/or for a second position of the imaged spot, etc.

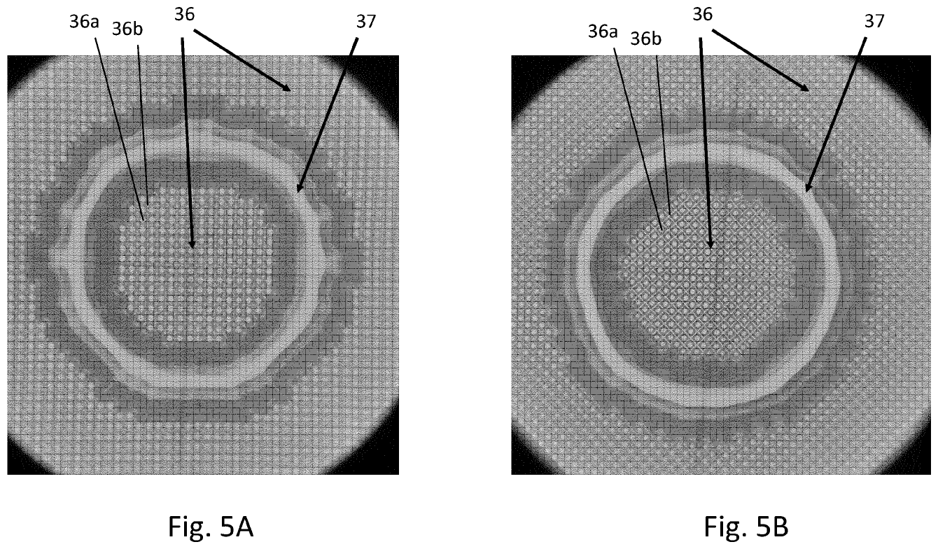

FIGS. 5A and 5B show a printing plate with solid reliefs 36 with a fine surface structure comprising hills 36a and valleys 36b (typically with a depth between 0.5 μm and 20 μm), obtained using an embodiment of the method disclosed above. The printing plate of FIG. 5A was obtained using a method similar to the method set out above in connection with FIG. 1, where no sampling pattern was added. FIG. 5A shows a round solid relief 36 surrounded by another solid relief 36. For completeness it is noted that FIG. 1 illustrates an example which results in a single ring-shaped solid relief, while FIG. 4A illustrates an example with two solids reliefs having a shape which is complementary to the ring shape of FIG. 1, but these are merely examples and a solid relief may have any desired shape. In between the two solid reliefs 36 there is a non-printing area in the form of a deep valley 37 having a depth (typically between 30 μm and 4 mm) which is significantly larger than the depth of the small valleys 36b of the surface structure on the solid reliefs 36. The printing plate of FIG. 5B was obtained using a method similar to the method set out above in connection with FIG. 3, where a sampling pattern was added. FIG. 5B shows a round solid relief 36 surrounded by another solid relief 36. In between the two solid reliefs 36 there is a non-printing area in the form of a ring-shaped deep valley 37 having a depth (typically between 30 μm and 4 mm) which is significantly larger than the depth of the small valleys 36b (typically with a depth between 0.5 μm and 20 μm) of the surface structure on the solid reliefs 36.

According to one embodiment, the depth of the valleys of the surface structure on the solid relief 36 is between 0.5 μm and 20 μm, preferably between 1 and 10 μm, more preferably between 3 and 10 μm. According to one embodiment, the depth of the valleys of the surface structure on the halftone dots (not shown in FIGS. 5A and 5B but could be combined with the solid reliefs of FIGS. 5A and 5B) is between 0.5 μm and 20 μm, preferably between 1 and 10 μm, more preferably between 3 and 10 μm. The total relief depth (i.e. the maximum relief depth in large areas where no imaging pixels are present) is preferably between 100 μm and 4 mm, more preferably between 100 μm and 2 mm, and most preferably between 100 μm and 1 mm. The intermediate relief depth (i.e. the relief depth in an area between halftone dots, if present (not shown in FIGS. 5A and 5B)) is preferably between 40 and 60% of the total intermediate depth, e.g. between 30 μm and 2 mm, more preferably between 40 μm and 1 mm. According to one embodiment, after the relief precursor is exposed and developed, a solid printing relief 36 with a first surface structure of hills surrounded by valleys is generated in a solid area, and multiple halftone dots (not shown) with a second surface structure of hills surrounded by valleys is generated in a halftone area.

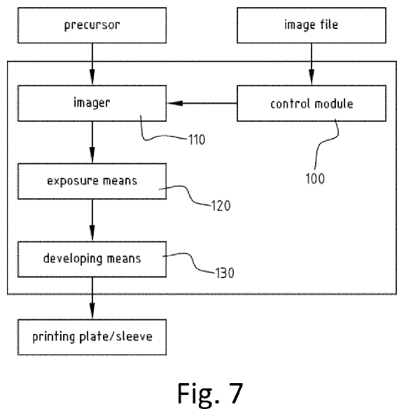

FIG. 7 illustrates a system to a relief printing plate or sleeve from a relief precursor. The system comprises a control module 100, an imager 110, an exposure means 120 and a developing means 130. After the mask layer on the precursor is imaged by the imager 110 using the modified image file and/or imaging instructions generated by the control module 100, the precursor is exposed to electromagnetic radiation in the exposure means 120, through the imaged mask layer so that a portion of the photosensitive layer 16 is cured. The electromagnetic radiation may have a wavelength in the range of 200 to 2000 nm, preferably it is ultraviolet (UV) radiation with a wavelength in the range of 200 to 450 nm.

The electromagnetic radiation changes the properties of the exposed parts of the photosensitive layer 16 such that in the following developing means non-exposed portions of the photosensitive layer are removed by the developing means 130 and a relief printing plate or sleeve is formed. Preferably, the developing is achieved by treatment with liquids (solvents, water or aqueous solutions) or by thermal development, wherein the liquefied or softened material is removed.

Treatment with liquids may be performed by spraying the liquid onto the precursor, brushing or scrubbing the precursor in the presence of liquid. The nature of the liquid used is guided by the nature of the precursor employed. If the layer to be removed is soluble, emulsifiable or dispersible in water or aqueous solutions, water or aqueous solutions might be used. If the layer is soluble, emulsifiable or dispersible in organic solvents or mixtures, organic solvents or mixtures may be used.

For thermal development, a thermal development means, wherein the flexible plate is fixed on the rotating drum, may be used. The thermal developing means further comprises assemblies for heating the at least one additional layer and also assemblies for contacting an outer surface of the heated, at least one additional layer with an absorbent material for absorbing material in a molten state. The assemblies for heating may comprise a heatable underlay for the flexible plate and/or IR lamps disposed above the at least one additional layer. The absorbent material may be pressed against the surface of the at least one additional layer by means, for example, of an optionally heatable roll. The absorbent material may be continuously moved over the surface of the flexible plate while the drum is rotating with repeatedly removal of material of the at least one additional layer. In this way molten material is removed whereas non-molten areas remain and form a relief.

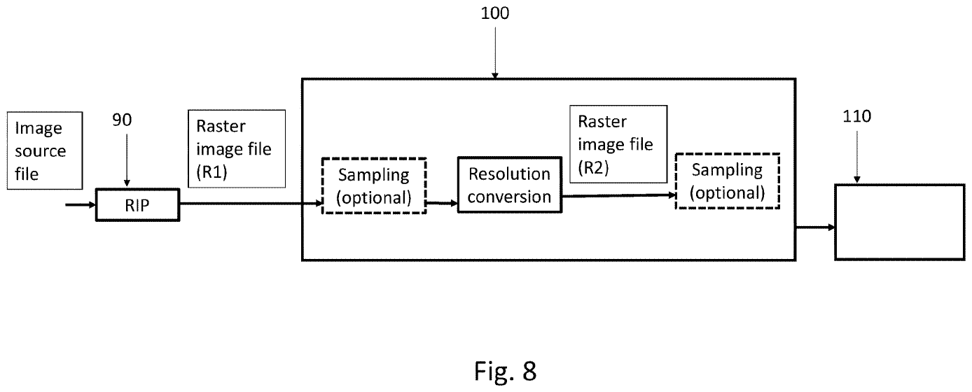

The relief printing plate or sleeve may be treated further and may finally be used as a printing plate. Optionally, the system may further a light finisher or any other post-exposure unit. Optionally, a controller may be provided to control the various units of the imaging system. Optionally, one or more pre-processing modules, such as a raster image processing (RIP) module which converts an image file, such as a pdf file, into a raster image process file, may be provided upstream of the control module 100, see also FIG. 8 which is discussed below.

FIG. 8 illustrates an exemplary embodiment of a control module 100 which is arranged downstream of a raster image processing module 90. The raster image processing (RIP) module 90 converts a source image file, such as a pdf or ps or xps file, into a raster image file (also called bitmap) with a first resolution R1. Raster image processing is the process of turning e.g. vector digital information such as a PostScript file into a high-resolution raster image file. Usually, the RIP module 90 is implemented either as a software component of an operating system or as a firmware program executed on a microprocessor. The RIP module 90 may further have a layout function. When a plurality of small images needs to be printed, those images may be grouped according to print patterns. This grouping may also be done by the RIP module 90.

The control module 100 is configured for receiving an image file comprising imaging pixels and non-imaging pixels at a first resolution R1; for generating, based on the image file, a modified image file comprising reduced-resolution imaging pixels and reduced-resolution non-imaging pixels at a second resolution R2 lower than the first resolution R1; and for controlling, based on the modified image file, the imager 110 such that imaged spots have a largest dimension smaller than (√2*P2), preferably smaller than P2.

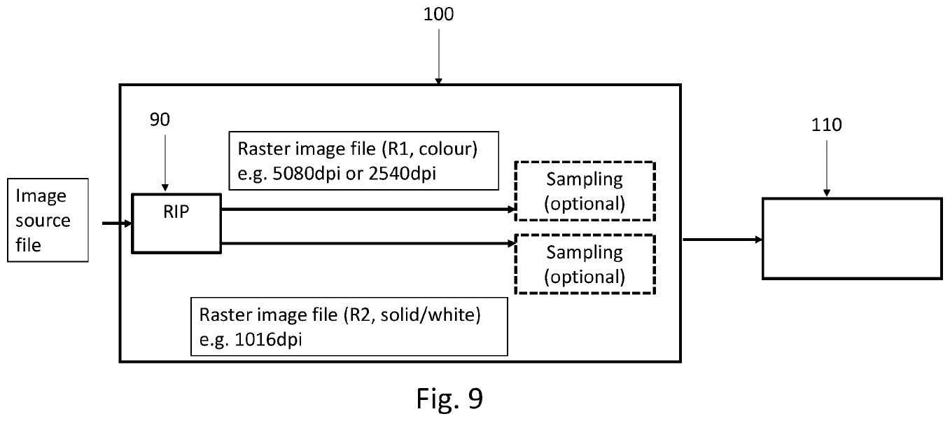

FIG. 9 shows an alternative embodiment of a control module 100. In this embodiment the raster image processing module 90 is included in the control module. The image source file is raster image processed to generate a first raster image file having a first resolution R1, e.g. 5080 dpi or 2540 dpi, for one or more halftone areas, typically the colours, to be printed and a second raster image process file having a lower second resolution R2 (corresponding with a second pitch P2), e.g. 1016 dpi, for one or more solid areas, e.g. one or more solid white areas, to be printed. In the example it is assumed that solid white areas have to be printed, but a similar method may be used when one or more solid areas in a specific colour need to be printed. Optionally a sampling pattern may be superimposed on the first and/or second raster image file. The resulting raster image file is then sent to the imager 110 in order to perform the imaging in accordance with the first and second raster image file, typically in two different passes, such that reduced-resolution imaging pixels of the white solid areas result in imaged spots have a largest dimension smaller than (√2*P2), preferably smaller than P2, and such that the halftone areas result in imaged spots which may have a largest dimension which is larger or smaller than P1.

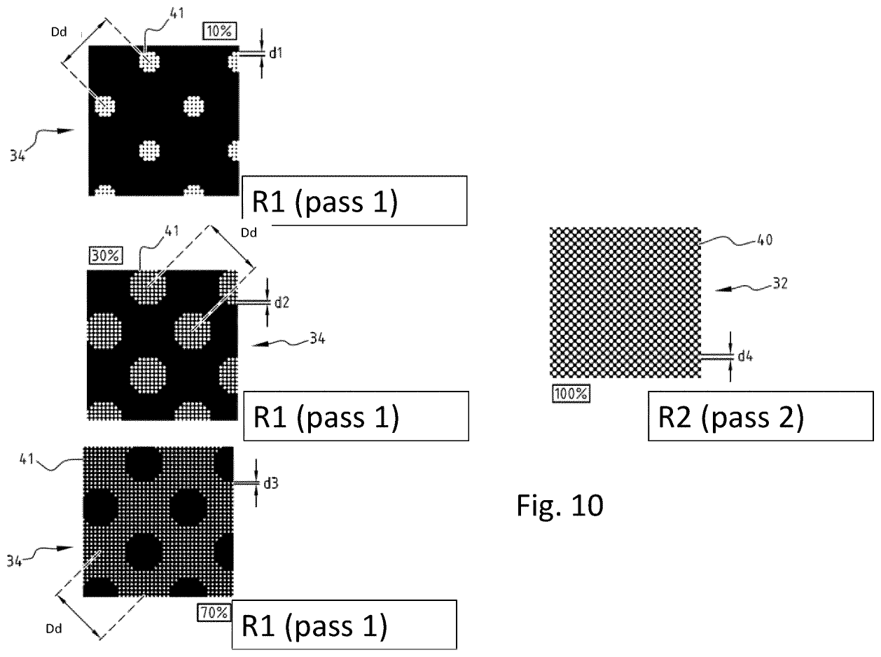

FIG. 10 illustrates a further exemplary embodiment of a method for imaging a mask layer. When an image file having a first resolution R1 is received, first the image file is analysed to detect any solid areas and any halftone areas in the image file. Next modified image files are generated, a first modified image file having a second resolution R2 lower than the first resolution R1, based on the pixels of the at least one solid area, and a second modified image file having the first resolution R1 based on pixels of the at least one halftone area. During a first pass the at least one halftone area 34 may be imaged using the second modified image file having the first resolution R1, see the left side of FIG. 10, and during a second pass the at least one solid area 32 may be imaged using the first modified image file having the second lower resolution R2, see the right side of FIG. 10. For illustrative purpose some portions of halftone areas (10%, 30% and 70%) are shown, but the skilled person understand that any combination of halftone areas may be present. As illustrated the diameter d1, d2, d3 of the imaged spots 41 may be different depending on the size of the dots of the respective halftone area 34. Typically, the diameter d4 of the imaged spots 40 in a solid area 32 may be larger than the diameter of the imaged spots in the halftone areas.

For example, for small tonal values, e.g. between 0 and 10%, a first diameter d1 may be used so that touching or overlapping imaged spots 41 are obtained, see the top left image of FIG. 10 and FIGS. 2B and 2C. For larger tonal values, e.g. between 10 and 50%, a second diameter d2 may be used which is smaller than d1 so that the imaged spots 41 are not overlapping, and for even larger tonal values, e.g. between 50 and 99%, an even smaller diameter d3<d2 may be used, see the middle and lower left image of FIG. 10. Alternatively, a sampling pattern could be used for those even larger tonal values in combination with a larger diameter. For the solid zone 32 (100%) a sampling pattern may be combined with a diameter d4>d1 but preferably smaller than P2, see the imaged spots 40 in the right image of FIG. 10 and see also FIG. 2A, 2D or 2E.

Embodiments of the invention are especially useful for classic amplitude modulated (AM) screens, where the distance Dd between adjacent dots of a halftone area is the same for halftone areas having different tonal values. The tonal value of the halftone area is then determined by the size of a group of clustered imaging pixels corresponding with clustered imaged spots 41 (i.e. the size of a dot). However, the skilled person understands that other embodiments of the invention may be used for frequency modulated (FM) screens or AM and FM screens, where the distance Dd is not constant.

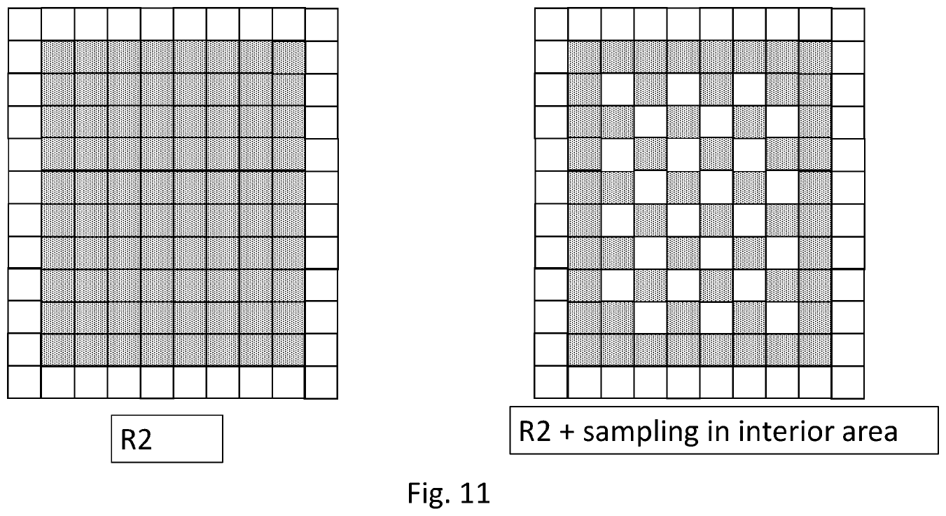

FIG. 11 illustrates a further exemplary embodiment of a method for imaging a mask layer. When an image file having a first resolution R1 is received, first a modified image file having a second resolution R2 lower than R1 is generated, see the image on the left side of FIG. 11. Next, the image file is analysed to detect at least one interior area and at least one edge area in the image file, and a sampling pattern is applied on the at least one interior area. Next the modified image file including the sampling pattern in the at least one interior area is used to image the at least one interior area. The imaging setting used in the interior area may be the same or different from the imaging setting used in the edge area. Optionally, the modified image file may have at least two bits per reduced resolution pixel, said at least two bits indicating for each reduced resolution pixel whether the pixel is one of the following: a reduced resolution non-imaging pixel, a reduced resolution imaging pixel to be imaged with a first imaging setting, a reduced resolution imaging pixel to be imaged with a second imaging setting different from the first imaging setting, and optionally a reduced resolution imaging pixel to be imaged with a third imaging setting different from the first and second imaging setting,

In another non-illustrated example the detecting of at least one interior area and at least one edge area may be done in the original image file, and the sampling pattern may be applied on the original image file before the resolution is lowered. The at least one interior area and the at least one edge area may comprise an interior area and an edge area of a solid area, and/or an interior area and an edge area of a dot of a halftone area.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

Whilst the principles of the invention have been set out above in connection with specific embodiments, it is to be understood that this description is merely made by way of example and not as a limitation of the scope of protection which is determined by the appended claims.

1-31. (canceled)

32. A method for imaging a mask layer of a printing plate precursor, comprising the steps:
provision of a mask layer of a printing plate precursor;
receiving a raster image file comprising imaging pixels and non-imaging pixels at a first resolution R1, said raster image file containing one or more solid areas;
based on the raster image file, generating a modified raster image file comprising reduced-resolution imaging pixels and reduced-resolution non-imaging pixels at a second resolution R2 lower than the first resolution R1, wherein a second pitch P2 corresponds to the second resolution R2, so that the second resolution R2 is used at least in said one or more solid areas;
based on the modified raster image file, imaging the mask layer such that imaged spots have a largest dimension smaller than (√2*P2), preferably smaller than P2.

33. A method for imaging a mask layer of a printing plate precursor, comprising the steps:
provision of a mask layer of a printing plate precursor;
receiving a raster image file comprising imaging pixels and non-imaging pixels at a first resolution R1, said raster image file containing one or more solid areas;
based on the raster image file, generating signals corresponding to reduced-resolution imaging pixels and reduced-resolution non-imaging pixels at a second resolution R2 lower than the first resolution R1, wherein a second pitch P2 corresponds to the second resolution R2, so that the second resolution R2 is used at least in said one or more solid areas;
based on the signals, imaging the mask layer such that imaged spots have a largest dimension smaller than (√2*P2), preferably smaller than P2.

34. The method of claim 32, wherein the modified raster image file is generated so that it has at least two bits per reduced resolution pixel, said at least two bits indicating for each reduced resolution pixel whether the pixel is one of the following:
a reduced resolution non-imaging pixel,
a reduced resolution imaging pixel to be imaged with a first imaging setting,
a reduced resolution imaging pixel to be imaged with a second imaging setting different from the first imaging setting,
optionally a reduced resolution imaging pixel to be imaged with a third imaging setting different from the first and second imaging setting,
wherein the imaging is done based on the modified raster image file.

35. The method of claim 32, further comprising detecting at least one solid area and at least one halftone area in the raster image file, wherein the generating of the modified raster image file is done based on the pixels of the at least one solid area, and the modified raster image is used to image the at least one solid area.

36. The method of claim 32, further comprising detecting at least one interior area and at least one edge area in the raster image file, wherein the generating of the modified raster image file is done based on the pixels of the at least one interior area, and the modified raster image is used to image the at least one interior area.

37. The method of claim 32, wherein the generating comprises determining that a reduced-resolution pixel of the modified raster image file is a reduced-resolution imaging pixel if the reduced-resolution pixel includes more imaging pixels than or the same number as non-imaging pixels in the raster image file, and, if not, determining that a reduced-resolution pixel is a reduced-resolution non-imaging pixel.

38. The method of claim 32, wherein prior to the generating, a sampling pattern is superimposed on pixels of the raster image file to obtain a sample image file in which a portion of the imaging pixels of the raster image file is changed into non-imaging pixels, and wherein the generating is based on the sampled image file.

39. A method for imaging a mask layer of a printing plate precursor, comprising the steps:
provision of a mask layer of a printing plate precursor;
receiving an image source file containing one or more solid areas and one or more halftone areas;
based on the image source file, generating a first raster image file comprising imaging pixels and non-imaging pixels at a first resolution R1 for said one or more halftone areas, wherein a first pitch P1 corresponds to the first resolution R1; and a second raster image file comprising reduced-resolution imaging pixels and reduced-resolution non-imaging pixels at a second resolution R2 lower than the first resolution R1 for said one or more solid areas, wherein a second pitch P2 corresponds to the second resolution R2;
based on the second raster image file, imaging the mask layer such that reduced-resolution imaging pixels of said one or more solid areas result in second imaged spots which have a largest dimension smaller than (√2*P2), preferably smaller than P2;
based on the first raster image file, imaging the mask layer such that said one or more halftone areas result in first imaged spots which have a largest dimension which is different from the largest dimension of the second imaged spots and smaller than (√2*P1), preferably smaller than P1.

40. The method of claim 39, wherein the first and/or the second raster image file is generated so that it has at least two bits per pixel, said at least two bits indicating for each pixel whether the pixel is one of the following:
a non-imaging pixel,
an imaging pixel to be imaged with a first imaging setting,
an imaging pixel to be imaged with a second imaging setting different from the first imaging setting,
optionally an imaging pixel to be imaged with a third imaging setting different from the first and second imaging setting,
wherein the imaging is done based on the first and second raster image file.

41. The method of claim 32, wherein a first pitch P1 corresponds with the first resolution R1, and wherein the imaging is done such that a largest dimension of the imaged spots is smaller than ⅓*P1+⅔*P2, preferably smaller than (P1+P2)/2, or even smaller than P1, and preferably larger than P1/2.

42. The method of claim 32, wherein the second resolution R2 is less than two-thirds of the first resolution R1, preferably equal to or less than half of the first resolution R1, and/or preferably no more than 3 times smaller than the first resolution R1.

43. The method of claim 32, wherein prior to or during the imaging of the mask layer, a sampling pattern is superimposed on the reduced-resolution pixels so that only a portion of the reduced-resolution imaging pixels is imaged.

44. The method of claim 32, wherein no sampling pattern is superimposed on the reduced-resolution pixels prior to or during the imaging of the mask layer.

45. The method of claim 32, wherein the mask layer is provided on a photopolymerizable layer of a relief precursor and wherein, after the imaging, the photopolymerizable layer of the relief precursor is exposed through the mask layer and the relief precursor is developed to obtain a relief structure.

46. A computer program comprising computer-executable instructions to control the method of claim 32, when the program is run on a computer.

47. A control module configured for
receiving a raster image file comprising imaging pixels and non-imaging pixels at a first resolution R1, said raster image file containing one or more solid areas;
based on the raster image file, generating a modified raster image file comprising reduced-resolution imaging pixels and reduced-resolution non-imaging pixels at a second resolution R2 lower than the first resolution R1, or generating signals corresponding to reduced-resolution imaging pixels and reduced-resolution non-imaging pixels at the second resolution R2, wherein a second pitch P2 corresponds to the second resolution R2, so that the second resolution R2 is used at least in said one or more solid areas;
based on the modified raster image file or the generated signals, controlling imaging of a mask layer of a printing plate precursor such that imaged spots have a largest dimension smaller than (√2*P2), preferably smaller than P2.

48. The control module of claim 47, wherein the generating comprises determining that a reduced-resolution pixel of the modified raster image file is a reduced-resolution imaging pixel if the reduced-resolution pixel includes more imaging pixels than or the same number as non-imaging pixels in the raster image file, and, if not, determining that a reduced-resolution pixel is a reduced-resolution non-imaging pixel.

49. The control module of claim 47, wherein the control module is configured to generate, based on the raster image file, a modified raster image file having at least two bits per reduced resolution pixel, said at least two bits indicating for each reduced resolution pixel whether the pixel is one of the following:
a reduced resolution non-imaging pixel,
a reduced resolution imaging pixel to be imaged with a first imaging setting,
a reduced resolution imaging pixel to be imaged with a second imaging setting different from the first imaging setting,
optionally a reduced resolution imaging pixel to be imaged with a third imaging setting different from the first and second imaging setting,
and to control the imaging based on the modified raster image file.

50. A control module configured for:
receiving an image source file containing one or more solid areas and one or more halftone areas;
based on the image source file, generating a first raster image file comprising imaging pixels and non-imaging pixels at a first resolution R1 for said one or more halftone areas, wherein a first pitch P1 corresponds to the first resolution R1; and a second raster image file comprising reduced-resolution imaging pixels and reduced-resolution non-imaging pixels at a second resolution R2 lower than the first resolution R1 for said one or more solid areas, wherein a second pitch P2 corresponds to the second resolution R2;
based on the second raster image file, controlling imaging of a mask layer of a printing plate precursor such that reduced-resolution imaging pixels of said one or more solid areas result in second imaged spots which have a largest dimension smaller than (√2*P2), preferably smaller than P2;
based on the first raster image file, imaging the mask layer such that said one or more halftone areas result in first imaged spots which have a largest dimension which is different from the largest dimension of the second imaged spots and smaller than (√2*P1), preferably smaller than P1.

51. The control module of claim 50, wherein the control module is configured to generate the first and/or the second raster image file so that it has at least two bits per pixel, said at least two bits indicating for each pixel whether the pixel is one of the following:
a non-imaging pixel,
an imaging pixel to be imaged with a first imaging setting,
an imaging pixel to be imaged with a second imaging setting different from the first imaging setting,
optionally an imaging pixel to be imaged with a third imaging setting different from the first and second imaging setting,
wherein the imaging is controlled based on the first and second raster image file.

52. The control module of claim 47, wherein a first pitch P1 corresponds with the first resolution R1, and wherein the imaging is done such that a largest dimension of the imaged spots is smaller than ⅓*P1+⅔*P2, preferably smaller than (P1+P2)/2, or even smaller than P1, and preferably larger than P1/2.

53. The control module of claim 47, wherein the second resolution R2 is less than two-thirds of the first resolution R1, preferably equal to or less than half of the first resolution R1, and/or preferably no more than 3 times smaller than the first resolution R1.

54. The control module of claim 47, wherein the control module is configured to superimpose a sampling pattern on the reduced-resolution pixels so that only a portion of the reduced-resolution imaging pixels is imaged.

55. A system for treating a printing plate precursor, comprising:
an imager configured to image a mask layer of a printing plate precursor;
a control module according to claim 51 to control the imager.

56. The system of claim 55, comprising any one or more of the following: at least one transport system configured to transport the relief precursor, a storage device, an exposure means configured to expose the relief precursor through the imaged mask layer, a developing means configured to remove at least a part of non-exposed material from the relief precursor, a drying system, a post-exposure device, a cutting device, a mounting station, a heater.
